(19) United States
(12) Patent Application Publication
(10) Pub. No.: US 2009/0214055 A1
(43) Pub. Date: Aug. 27, 2009

(54) Noise cancelling device and noise cancelling method

(75) Inventor: Tokihiko Sawashi, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/380,257

(22) Filed: Feb. 25, 2009

(30) Foreign Application Priority Data
Feb. 26, 2008 (JP) P2008-044821

(51) Int. Cl. H04B 15/00

(52) U.S. Cl. 381/94.1; 381/71.1

(57) ABSTRACT

A noise cancelling device includes a microphone; an opposite-phase circuit configured to invert a phase of a sound signal that is obtained by the microphone, thereby obtaining an opposite-phase sound signal; and a speaker configured to receive the opposite-phase sound signal that is obtained by the opposite-phase circuit, and to output a sound. The microphone is disposed at a point which is a point other than a specified listening point, the listening point being located a predetermined distance from the speaker, and at which, as a sound-pressure level of the sound that was output from the speaker, a sound-pressure level that is substantially the same as a sound-pressure level which is obtained at the listening point is obtained.

### CROSS REFERENCES TO RELATED APPLICATIONS

The present invention contains subject matter related to Japanese Patent Application JP 2008-044821 filed in the Japanese Patent Office on Feb. 26, 2008, the entire contents of which are incorporated herein by reference.

### BACKGROUND OF THE INVENTION

1. Field of the Invention

The present invention relates to a noise cancelling device and noise cancelling method for reducing extraneous noise.

2. Description of the Related Art

Documents concerning the related art are as follows: Japanese Unexamined Patent Application Publication No. 8-237788; Japanese Unexamined Patent Application Publication No. 10-11901; and Japanese Patent No. 3,561,920.

Recently, a noise cancelling function has been broadly put to practical use in systems for listening music or the like using headphones (earphones). A method for realizing the noise cancelling function in this case includes the following: disposing a microphone for collecting noise at the position of a user's ear, which is referred to as a “listening point”; inverting the phase of a sound signal (a sound signal corresponding to extraneous noise) that is obtained by the microphone, thereby obtaining an opposite-phase sound signal (an opposite-phase noise signal); and outputting a sound that is generated using the opposite-phase sound signal, which is obtained by phase inversion, from a speaker of each of headphones.

Parts (a) to (d) of FIG. 5 schematically illustrate the operation of the noise cancelling function that is realized using the above-mentioned method.

It is supposed that a speaker 30 shown in part (a) of FIG. 5 is provided in, for example, each of headphones or earphones. A user wears the headphones over user's ears. Accordingly, a listening point PL at which the user listens to a sound that was output from the speaker 30 is very close to the front of the speaker 30. In this case, although a microphone 31 is provided in each of the headphones (or the earphones) in order to realize the noise cancelling function, the microphone 31 can be placed in the immediate vicinity of the listening point PL (i.e., at a position that is almost the same as the position of a user's ear).

Extraneous noise, such as noise from external devices, reaches points in an environment in which the user listens to a sound. Note that, generally, because the various types of sound sources that are noise sources are sufficiently distant from the listening point PL, the sound wave of the extraneous noise reaches the points as a plane wave. In this case, there is almost no difference among noise levels in the vicinity of the listening point PL.

The reason for this is as follows: a wave of a sound is emitted as a spherical wave from a sound source, and the sound-pressure level of the sound in the vicinity of the sound source is markedly attenuated with distance from the sound source; however, the more distant from the sound source the point which the wave of the sound reaches is, the less the sound-pressure level, which is attenuated with distance from the sound source, is attenuated; and there is almost no difference between sound-pressure levels that are caused by some difference between distances between the sound source and points at which the wave of the sound is recognized almost as a plane wave.

As shown in part (b) of FIG. 5, it is supposed that the noise level of noise that reaches the points is “1”.

The noise is collected by the microphone 31 to obtain a noise signal. The phase of the noise signal is inverted by an internal circuit, thereby generating an opposite-phase noise signal. A sound that is generated using the opposite-phase noise signal is output from the speaker 30. The sound that is output from the speaker 30 is emitted as a spherical wave. The sound-pressure level of the sound is attenuated with distance from the speaker 30, and the attenuation of the sound-pressure level is high in the vicinity of the speaker 30.

However, when the listening point PL is very close to the speaker 30, the attenuation of the sound that was output from the speaker 30 is low at the listening point PL.

Accordingly, regarding the sound which was generated using the opposite-phase noise signal and which was output from the speaker 30, the sound-pressure level of the sound at the listening point PL is approximately “0.9” (−1 dB), for example, as shown in part (c) of FIG. 5.

Thus, the extraneous noise is appropriately cancelled with the sound that was generated using the opposite-phase noise signal at the listening point PL. Residual noise at the listening point PL is, for example, approximately −20 dB, as shown in part (d) of FIG. 5.

In other words, the extraneous noise that the user notice can be appropriately reduced.

### SUMMARY OF THE INVENTION

The above-described noise cancelling function is successfully realized by employing a system using headphones or earphones.

In other words, the position of the microphone 2, which is a noise-observing point, can be set so that the microphone 2 is disposed at a position that is almost the same as the position of a user's ear, which is the listening point PL. Thus, the sound that is generated using a cancel signal (the opposite-phase noise signal) can be output from the speaker 30 so that the most appropriate noise cancelling effect can be obtained at the position of the user's ear.

For example, realization of the noise cancelling function in, for example, an automobile is considered.

However, when it is desired that the noise cancelling function be realized in an automobile, making an occupant such as a driver wear headphones is not appropriate for the security reasons or the like.

Thus, it is necessary that, in an environment such as in an automobile, a microphone or a speaker be mounted at a position which is distant from an ear of an occupant, e.g., in a headrest of a seat or the ceiling of the automobile, without directly wearing the speaker or the microphone over a head, and that a noise cancelling effect be obtained at a listening point which is the position of the ear of the occupant and which is distant from the microphone or the speaker.

However, when the microphone that collects noise is distant from the listening point, the noise cancelling effect is described as follows. An opposite-phase noise signal that is to be used for the noise cancelling effect is generated on the basis of noise that is collected at the position of the microphone, and a sound that is generated using the opposite-phase noise signal is output. In such case, when the sound-pressure level of the sound that was generated using the opposite-phase noise signal is observed at the listening point, the sound-pressure level of the sound is attenuated because the microphone is distant from the listening point. Thus, it is difficult to obtain an appropriate noise cancelling effect.

The case in which an appropriate noise cancelling effect is difficult to be obtained is described with reference to FIG. 6.

As shown in part (a) of FIG. 6, it is supposed that the listening point PL (the position of the user's ear) is located, for example, approximately 15 cm from a sound-emitting surface of the speaker 30. In addition, it is supposed that the microphone 31 is disposed at a position that is located in the very front of the speaker 30 as in the case of FIG. 5.

Regarding the sound-pressure level of the extraneous noise that reaches points as a plane wave, there is almost no difference between the sound-pressure level that is measured at the position of the microphone 31 and the sound-pressure level that is measured at the listening point PL for the above-mentioned reason.

It is supposed that the noise level of the extraneous noise is “1” as shown in part (b) of FIG. 6.

In this case, a noise signal is generated using the extraneous noise that is collected by the microphone 31. The phase of the noise signal is inverted by the internal circuit, thereby generating an opposite-phase noise signal. A sound that is generated using the opposite-phase noise signal is output from the speaker 30.

However, immediately after the sound that was generated using the opposite-phase noise signal is output from the speaker 30 as a spherical wave, the sound is highly attenuated with distance from the speaker 30. For example, when the sound-pressure level of the sound that was generated using the opposite-phase noise signal is measured at the listening point PL which is located 15 cm from the speaker 30, it is “0.32” (−10 dB) as shown in part (c) of FIG. 6.

In this case, the noise cancelling effect using the sound that was generated using the opposite-phase noise signal is markedly low. When a residual noise level is measured at the listening point PL, it is −3.3 dB as shown in part (d) of FIG. 6. As shown by the comparison between the case shown in part (d) of FIG. 6 and the case shown in part (d) of FIG. 5, it is difficult to obtain an appropriate noise cancelling effect.

As described above, it is difficult to obtain an appropriate noise cancelling effect in a system in which headphones or the like are not used. However, in view of the above-described circumstances, it is desirable to provide a technology in which an appropriate noise cancelling effect can be obtained even when headphones or the like are not use, i.e., even when a microphone that collects noise is not disposed very close to a listening point.

According to an embodiment of the present invention, there is provided a noise cancelling device including the following elements: a microphone; an opposite-phase circuit configured to invert a phase of a sound signal that is obtained by the microphone, thereby obtaining an opposite-phase sound signal; and a speaker configured to receive the opposite-phase sound signal that is obtained by the opposite-phase circuit, and to output a sound. The microphone is disposed at a point which is a point other than a specified listening point, the listening point being located a predetermined distance from the speaker, and at which, as a sound-pressure level of the sound that was output from the speaker, a sound-pressure level that is substantially the same as a sound-pressure level which is obtained at the listening point is obtained.

According to an embodiment of the present invention, there is provided a noise-cancelling method including the following: disposing a microphone at a point which is a point other than a specified listening point, the listening point being located a predetermined distance from a speaker, and at which, as a sound-pressure level of a sound that was output from the speaker, a sound-pressure level that is substantially the same as a sound-pressure level which is obtained at the listening point is obtained; inverting a phase of a sound signal that is obtained by the microphone, thereby obtaining an opposite-phase sound signal; and supplying the opposite-phase sound signal, which is obtained by phase inversion, to the speaker, and outputting a sound.

The sound that was output from the speaker is attenuated at the listening point, which is located a predetermined distance from the speaker. The sound-pressure level of the sound that was output from the speaker is attenuated at the listening point, and a point at which an attenuation of the sound-pressure level that is substantially the same as an attenuation of the sound-pressure level which is measured at the listening point is measured exists in the vicinity of the speaker where the wave of the sound is emitted as a spherical wave.

A sound that is collected by the microphone is a sound corresponding to the difference between extraneous noise and the sound that was output from the speaker (i.e., a sound which was generated using an opposite-phase noise signal and which is used for a noise cancelling function). When the microphone is placed at the above-mentioned point (at which an attenuation of the sound-pressure level that is substantially the same as an attenuation of the sound-pressure level which is measured at the listening point PL is measured), a noise level that is determined on the basis of the sound that is collected by the microphone is the same as the residual noise level of residual noise that a user notices at the listening point.

Thus, a sound signal is obtained using the sound that is collected by the microphone, and the phase of the sound signal is inverted, thereby generating an opposite-phase sound signal (the opposite-phase noise signal). A sound that is generated using the opposite-phase sound signal is output from the speaker. In this case, the sound is output so that it causes the residual noise at the listening point to be reduced.

According to the embodiment of the present invention, in a simple technique in which the opposite-phase sound signal (the opposite-phase noise signal) is generated using noise that is collected by the microphone, and in which a sound that is generated using the opposite-phase sound signal is output, an appropriate noise cancelling effect can be exerted at the listening point even when the listening point is distant from the speaker and the microphone.

Therefore, even when a user does not use headphones or the like in, for example, an automobile, or an aircraft, an environment can be created, in which the user substantially does not notice noise due to the noise cancelling effect.

### BRIEF DESCRIPTION OF THE DRAWINGS

FIG. 1 is a diagram of a configuration of a noise cancelling device according to an embodiment of the present invention;

FIG. 2 includes illustrations showing a state in which the noise cancelling device according to the embodiment is specifically placed;

FIG. 3 includes diagrams showing a position at which a microphone in the embodiment is disposed;

FIG. 4 is a diagram illustrating an effect that is obtained using the noise cancelling device according to the embodiment;

FIG. 5 includes diagrams illustrating a noise cancelling effect that is obtained when a listening point is close to a speaker and the microphone; and

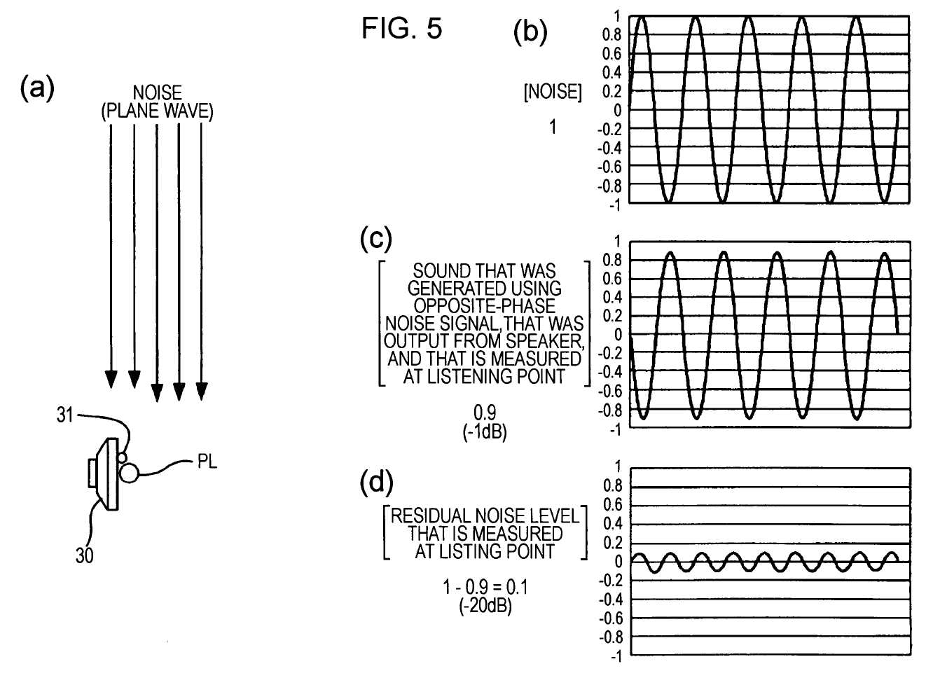

FIG. 6 includes diagrams illustrating that the noise cancelling effect is reduced when the listening point is distant from the speaker and the microphone.

### DESCRIPTION OF THE PREFERRED EMBODIMENTS

Embodiments of the present invention will be described below.

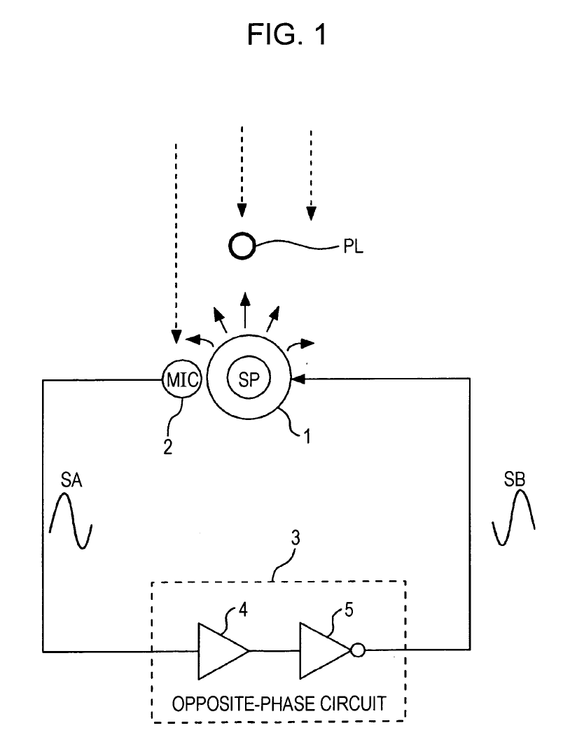

FIG. 1 shows a configuration of a noise cancelling device according to an embodiment.

In the noise cancelling device according to the embodiment, a microphone 2 is disposed at a predetermined position given below for a speaker 1. Additionally, an opposite-phase circuit 3 including a microphone amplifier 4 and an inverting amplifier 5 is provided.

A sound signal SA is obtained by the microphone 2, and the phase of the sound signal SA is inverted by the opposite-phase circuit 3, thereby generating an opposite-phase sound signal SB. The opposite-phase sound signal SB is supplied to the speaker 1 and a sound that is generated using the opposite-phase sound signal SB is output from the speaker 1.

A listening point PL shown in FIG. 1 corresponds to, for example, the position of a user's ear.

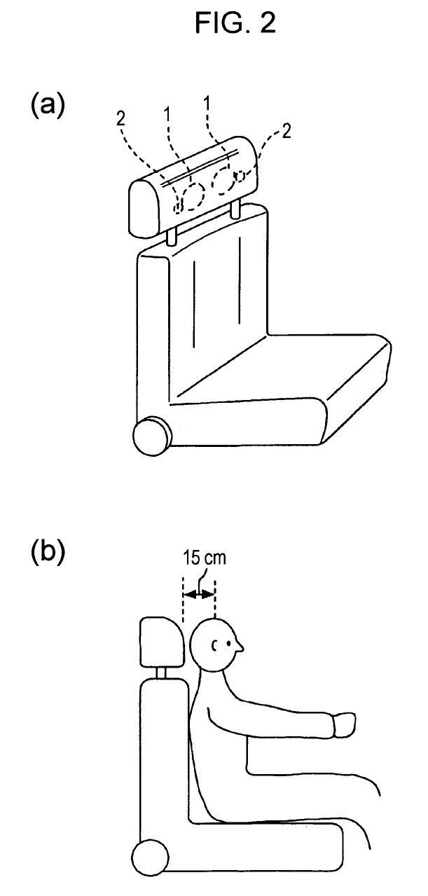

Part (a) of FIG. 2 shows a state in which, for example the speaker 1 and the microphone 2 are mounted in a headrest of a seat of an automobile or the like. For example, in consideration of a state in which the user sits down as shown in part (b) of FIG. 2, the position of the user's ear is located approximately 15 cm from a sound-emitting surface of the speaker 1.

It is assumed that the listening point PL shown in FIG. 1 is located approximately 15 cm from the front of the speaker 1 as described above.

Extraneous noise reaches the surroundings of the user and the microphone 2 as a plane wave as indicated by the broken lines shown in FIG. 1.

Furthermore, the sound that was output from the speaker 1 is emitted as a spherical wave, and reaches the listening point PL. The sound also reaches the microphone 2.

Accordingly, the extraneous noise and the sound that was output from the speaker 1 are collected by the microphone 2. In other words, the extraneous noise and the sound that was output from the speaker 1 are collected, i.e., a sound is collected in a state in which the extraneous noise is cancelled with the sound that is an opposite-phase element of the extraneous noise and that was output from the speaker 1. The collected sound is obtained as the sound signal SA. Then, the opposite-phase sound signal SB is generated by the opposite-phase circuit 3, and a sound that is generated using the opposite-phase sound signal SB is output from the speaker 1.

In this embodiment, a noise cancelling effect is obtained at the listening point PL in such a feedback system.

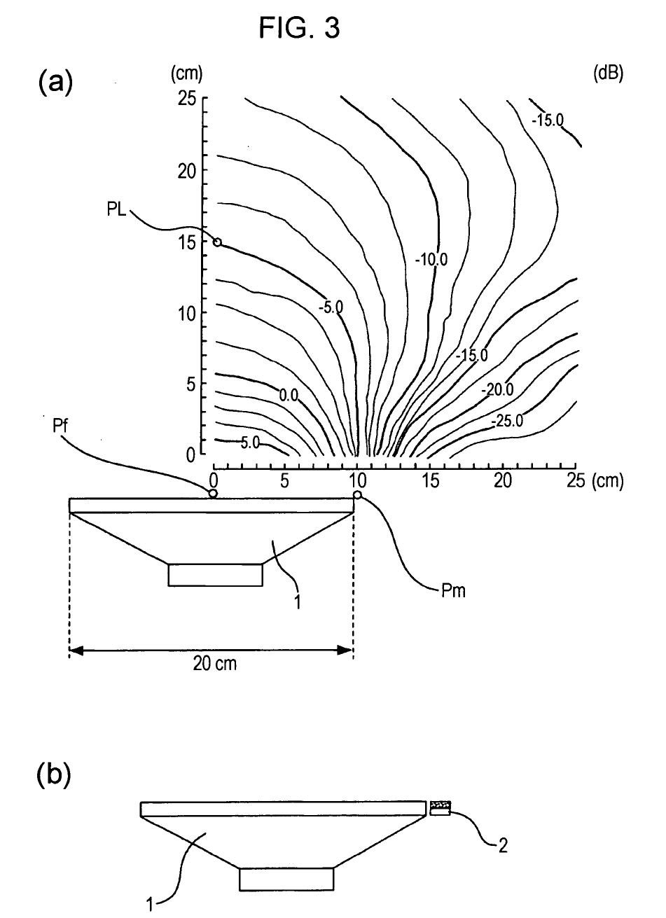

Herein, the following description is made with reference to FIG. 3.

Part (a) of FIG. 3 shows a result that was obtained by measuring sound pressure in a state in which the speaker 1 having an aperture of 20 cm was not placed in an enclosure, i.e., in a state in which the speaker 1 was not covered with anything. The sound pressure (dB) of the sound that was output from the speaker 1 was measured in a region which is located on the front-right side of the speaker 1, and constant-sound-pressure curves of the measured sound pressure are shown in part (a) of FIG. 3.

The sound that was output from the speaker 1 is emitted as a spherical wave. Accordingly, as indicated by the constant-sound-pressure curves, the sound that was output from the speaker 1 is diffused and attenuated with distance from the speaker 1.

Generally, the sound level of the sound that was output from the speaker 1 is attenuated in inverse proportion to the square of the distance from the speaker 1.

Supposing that the listening point PL (the position of the user's ear) is located approximately 15 cm from the speaker 1 as shown in part (b) of FIG. 2, the attenuation of sound is observed in accordance with the distance from the speaker 1.

In an actual experiment shown in part (a) of FIG. 3, when the sound pressure of the sound that was output from the speaker 1 was measured, a result was obtained as follows: a sound pressure which was measured at a position PF, which is located at the very front of the speaker 1, was approximately 6 dB; and a sound pressure which was measured at a position that is located 15 cm from the speaker 1 was approximately −5 dB. In other words, an attenuation that was measured at a position that is located 15 cm from a sound source was confirmed to be 10 dB or more.

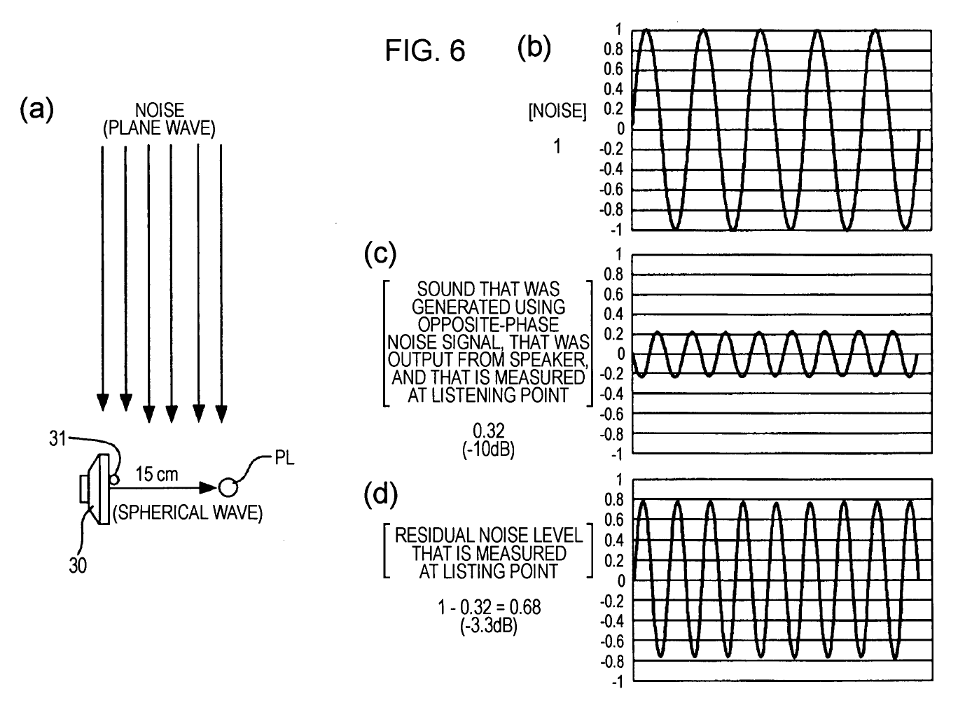

It is supposed that the listening point PL is located 15 cm from the speaker 1, that the microphone 2 is disposed at the position PF, which is located at the very front of the speaker 1, and that the sound which was output from the speaker 1 and the extraneous noise are collected (i.e., that a sound corresponding to the difference between the sound which was output from the speaker 1 and the extraneous noise is collected). In such a case, even when an opposite-phase sound signal whose phase is opposite to the phase of the collected sound is generated and when a sound that is generated using the opposite-phase sound signal is output from the speaker 1, the sound pressure of the sound that was generated using the opposite-phase sound signal is attenuated by approximately 10 dB at the listening point PL. As a result, this case is similar to the case that is described with reference to FIG. 6. In other words, no effective noise cancelling effect is obtained at the listening point PL.

In this embodiment, the position of the microphone 2 is determined so that the noise cancelling effect can be reliably obtained at the listening point PL.

For example, when an environment illustrated in part (b) of FIG. 2 is considered, the position of the listening point PL is located approximately 15 cm from the speaker 1. In reality, there is no other choice but to dispose the microphone 2 in a headrest or the like (at any position distant from the user's ear although the microphone 2 is not necessarily disposed in the headrest) as in the case of the speaker 1 as shown in part (a) of FIG. 2. The reason for this is that attaching an arm or the like to the microphone 2 and disposing the microphone 2 at a position that is very close to the ear is not appropriate in reality. In addition, when the microphone 2 is disposed at such a position, the existence of the microphone 2 is uncomfortable for the user.

According to the result shown in part (a) of FIG. 3, the spaces between the constant-sound-pressure curves that are drawn in the vicinity of the outer periphery of the speaker 1 and on the outer side of the outer periphery of the speaker 1 are narrower than the spaces between the constant-sound-pressure curves that are drawn so as to be spaced in a direction away from the front of the speaker 1. A sound-pressure level that was measured at a point Pm, which is located in the vicinity of the outer periphery of the speaker 1, is substantially the same as a sound-pressure level that was measured at the listening point PL, which is located 15 cm from the front of the speaker 1.

In contrast, regarding the sound-pressure level of the extraneous noise that reaches points as a plane wave, there is almost no difference between a sound-pressure level of the extraneous noise that was measured at the listening point PL and a sound-pressure level of the extraneous noise that was measured at the point Pm. In other words, conditions at each point indicate the relationships between the sound pressure of the sound that was output from the speaker 1 and the noise level of the extraneous noise, and conditions at the point Pm are substantially the same as conditions at the listening point PL. In other words, a noise environment at the point Pm is the same as that at the listening point PL.

Accordingly, as shown in part (b) of FIG. 3, the microphone 2 is disposed at the position of the point Pm that is shown in part (a) of FIG. 3.

In the above-mentioned case, a sound corresponding to the difference between the sound that was output from the speaker 1 and the extraneous noise is collected by the microphone 2 under conditions that are the same as conditions at the listening point PL.

The system of the noise cancelling device shown in FIG. 1 is configured as a feedback loop. An opposite-phase sound signal is generated using a sound signal that is obtained by the microphone 2, and a sound that is generated using the opposite-phase sound signal is output from the speaker 1, so that noise is cancelled or attenuated. Then, residual noise that remains after the noise is cancelled (i.e., a sound corresponding to the difference between the sound that was output from the speaker 1 and the extraneous noise,) is collected again by the microphone 2, and is fed back to the system of the noise cancelling device.

Thus, the system of the noise cancelling device shown in FIG. 1 effectively functions to cancel noise at the point Pm. That is, a sufficient noise cancelling effect can be also obtained at the listening point PL as at the point Pm.

As described above, in this embodiment, supposing that the specified listening point PL is located a predetermined distance, such as 15 cm, from the speaker 1, the microphone 2 is disposed at the point Pm. The point Pm is a point other than the listening point PL, and, at the point Pm, a sound-pressure level that is substantially the same as a sound-pressure level which is measured at the listening point PL can be measured as a sound-pressure level of the sound that was output from the speaker 1. In addition, the configuration of the noise cancelling device shown in FIG. 1 is employed. In this manner, the noise cancelling effect can be improved at the listening point PL, which is distant from the speaker 1 and the microphone 2.

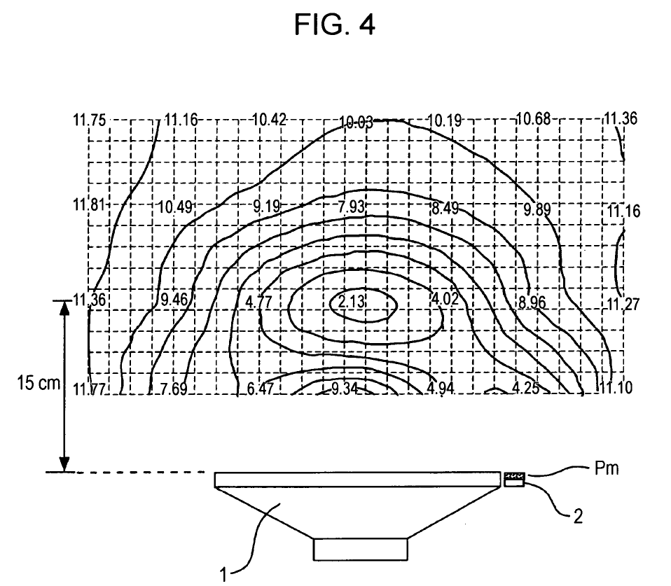

FIG. 4 shows constant-sound-pressure curves that were obtained by measuring noise levels at the front of the speaker 1 when the microphone 2 was mounted in the vicinity of the outer periphery of the speaker 1 (i.e., at the point Pm).

In FIG. 4, each of the noise levels, which were measured at corresponding points, is shown. Noise levels of approximately 11 to 12 dB were measured in the vicinity of the outer periphery of the speaker 1 shown in FIG. 4.

In contrast, noise levels of approximately 2 dB were measured in the vicinity of a position that is located 15 cm from the front of the speaker 1. A noise cancelling effect of approximately 10 dB was obtained.

In this embodiment, as described above, a sufficient noise cancelling effect can be obtained at the listening point PL, which is distant from the speaker 1 and the microphone 2. Thus, for example, a condition under which a user substantially does not notice noise can be generated in an environment in an automobile, such as in the environment illustrated in part (b) of FIG. 2. In other words, the noise cancelling device according to the embodiment serves as a noise cancelling device that is effectively employed in an automobile, an aircraft, a train, or the like.

As a matter of course, the noise cancelling device can be easily employed in various environments, for example, because it is not necessary for a user to wear headphones or the like, or because it is not necessary to dispose the microphone 2 at a position in the vicinity of a user's ear.

The above embodiment has been described under the assumption that the listening point PL is located 15 cm from the speaker 1. However, as a matter of course, the distance between the listening point PL and the speaker 1 changes in accordance with the design of an automobile in which the noise canceling device according to the embodiment is mounted or the like, or in accordance with the position at which the speaker 1 is placed. For example, when the speaker 1 and the microphone 2 are disposed in the dashboard or ceiling of an automobile, or the like, the listening point PL is located approximately 20 to 30 cm from the speaker 1 in some cases. Accordingly, in reality, an environment in which the noise cancelling device according to the embodiment is to be placed (for example, the type of automobile in which the noise cancelling device according to the embodiment is to be placed) is assumed, and the position of the microphone 2 is set. In other words, as indicated by the constant-sound-pressure curves shown in part (a) of FIG. 3 or the like, supposing that the listening point PL is located any one of various distances from the front of the speaker 1, a position at which a sound-pressure level that is the same as a sound-pressure level which is measured at the listening point PL can be measured exists in the vicinity of the speaker 1. Thus, it is only necessary to dispose the microphone 2 at the above position.

Furthermore, for example, when the microphone 2 is placed in a seat, the ceiling of an automobile, or the like, the most appropriate position of the microphone 2 changes in accordance with how a user sits down, the user's sitting height, or the like. Thus, a mechanism capable of adjusting the position of the microphone 2 may be provided.

It should be understood by those skilled in the art that various modifications, combinations, sub-combinations and alterations may occur depending on design requirements and other factors insofar as they are within the scope of the appended claims or the equivalents thereof.

What is claimed is:

1. A noise cancelling device comprising:
a microphone;
an opposite-phase circuit configured to invert a phase of a sound signal that is obtained by the microphone, thereby obtaining an opposite-phase sound signal; and
a speaker configured to receive the opposite-phase sound signal that is obtained by the opposite-phase circuit, and to output a sound,
wherein the microphone is disposed at a point which is a point other than a specified listening point, the listening point being located a predetermined distance from the speaker, and at which, as a sound-pressure level of the sound that was output from the speaker, a sound-pressure level that is substantially the same as a sound-pressure level which is obtained at the listening point is obtained.

2. A noise-cancelling method comprising the steps of:
disposing a microphone at a point which is a point other than a specified listening point, the listening point being located a predetermined distance from a speaker, and at which, as a sound-pressure level of a sound that was output from the speaker, a sound-pressure level that is substantially the same as a sound-pressure level which is obtained at the listening point is obtained;
inverting a phase of a sound signal that is obtained by the microphone, thereby obtaining an opposite-phase sound signal; and
supplying the opposite-phase sound signal, which is obtained by phase inversion, to the speaker, and outputting a sound.
